(19) United States
(12) Patent Application Publication
(10) Pub. No.: US 2024/0368400 A1
(43) Pub. Date: Nov. 7, 2024

(54) THERMOPLASTIC COMPOSITION

(71) Applicant: SABIC Global Technologies B.V., Bergen op Zoom (NL)

(72) Inventors: Roshan Kumar Jha, Bangalore (IN); Dashrath Patel, Vadodara (IN); Sunil Rauto, Bangalore (IN); Rukmini Khatokar, Bangalore (IN)

(21) Appl. No.: 18/285,687

(22) PCT Filed: Apr. 4, 2022
(86) PCT No.: PCT/EP2022/058828

§ 371 Date: Oct. 5, 2023

(30) Foreign Application Priority Data
Apr. 6, 2021 (EP) 21166891.8

(51) Int. Cl. C08L 69/00

(52) U.S. Cl. CPC C08L 69/00; C08L 2205/03

(57) ABSTRACT

The present invention relates to a thermoplastic composition comprising, based on the weight of the composition, (A) from 50-65 wt. % of aromatic polycarbonate, (B) from 20-40 wt. % of polyester comprising or consisting of poly(butylene terephthalate), (C) from 1-10 wt. % of impact modifier, (D) from 5-15 wt. % of glass fibres, (E) from 0-5 wt. % of further components, wherein the sum of the components (A)-(E) is 100 wt. % and wherein the composition has a notched Izod impact strength determined in accordance with ISO 180-1A at a temperature of 23° C. of at least 10 kJ/m2, a tensile modulus determined in accordance with ISO 527 at a temperature of 23° C. of at least 4.0 GPa, a tensile strength determined in accordance with ISO 527 at a temperature of 23° C. of at least 75 MPa and a melt volume rate determined in accordance with ISO 1133 (2505° C., 5 kg) of at least 7.0 cc/10 min.

### CROSS-REFERENCE TO RELATED APPLICATIONS

This application is a National Stage application of PCT/EP2022/058828, filed Apr. 4, 2022, which claims the benefit of European Application No. 21166891.8, filed Apr. 6, 2021, both of which are incorporated by reference in their entireties herein.

### BACKGROUND

The present invention relates to a thermoplastic composition comprising aromatic polycarbonate, polyester, impact modifier and glass fibres.

Such compositions are known per se in the prior art and may be used in indoor or outdoor automotive applications. For example the material may be used for door handles or brackets used to support such handles. Typically such handles or brackets are mechanically fastened to a support structure such as a door or a tailgate allowing the same to be opened using the said handle or bracket.

In view of the repetitive loads, changing temperature and general requirements for such parts, the composition that is used for its manufacture needs to exhibit a specific combination of features. For example, on the one hand the material needs to have a sufficient stiffness in order not to significantly deform during use while at the same time the material is required to have sufficient toughness over a wide temperature range in order to secure the integrity of the mechanical connection between the part and the support structure. In addition to that the composition needs to have a sufficiently high melt flow rate so that the parts can be moulded in an economically efficient manner.

U.S. Pat. No. 9,187,639 discloses a blended thermoplastic composition comprising a) from about 30 wt. % to about 75 wt. % of a polycarbonate polymer; b) from about 1 wt. % to about 15 wt. % of a polyester polymer; and c) from greater than 30 wt. % to about 60 wt. % of a reinforcing filler; wherein the combined weight percent value of all components does not exceed about 100 wt %; wherein all weight percent values are based on the total weight of the composition; and wherein a molded sample of the blended thermoplastic composition has an unnotched Izod impact strength when determined in accordance with ASTM D4812 of at least about 15% greater than a reference composition comprising substantially the same proportions of the same polycarbonate polymer component and the same reinforcing fiber, in the absence of the polyester polymer.

U.S. Pat. No. 9,296,894 discloses a composition comprising 45 to 85 weight percent of a polycarbonate comprising 35 to 75 weight percent of a copolyestercarbonate comprising ester units of the formula

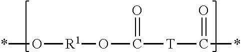

wherein, independently in each ester unit, R¹ is an unsubstituted or substituted divalent C₆-C₃₀ aromatic group; and T is an unsubstituted or substituted C₄-C₁₈ aliphatic divalent group; and carbonate units of the formula

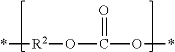

wherein, independently in each carbonate unit, R² is a radical of the formula

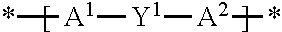

wherein each of A¹ and A² is independently a monocyclic divalent aryl radical and Y¹ is a bridging radical having one or two atoms that separate A¹ from A²; and
10 to 30 weight percent of a polycarbonate-polydiorganosiloxane block copolymer;
10 to 30 weight percent of poly(butylene terephthalate); and
5 to 20 weight percent reinforcing filler;
wherein all weight percents are based on the total weight of the composition.

The composition in this document is disclosed to exhibit a desirable balance of melt flow and ductility, is especially useful for forming thin plastic parts of consumer electronic devices, including mobile phones.

US 2004/147655 discloses a resin composition comprising (A) a polycarbonate having a viscosity average molecular weight of at least 10,000 obtained by filtration in a molten state with a filter comprising an assembly of a plurality of disk filter elements having an outer diameter of 15 inches (+/−38.1 cm) or less, an inner diameter/outer diameter ratio of 1/7 or more and an opening size of 40 μm or less; and (B) at least one member selected from the group consisting of an inorganic filler (BI) and a thermoplastic resin (B2) other than polycarbonates.

US 2008/246181 discloses a composition comprising, based on the total weight of the composition, from 10 to 80 wt. % of a modified polybutylene terephthalate copolymer that
(1) is derived from polyethylene terephthalate component selected from the group consisting of polyethylene terephthalate and polyethylene terephthalate copolymers and
(2) has at least one residue derived from the polyethylene terephthalate component;
from 10 to 80 wt. % of a polycarbonate;
from 0 to 20 wt. % of an impact modifier;
from 1 to less than 25 wt. % of a reinforcing filler;
from 0.1 to less than 2.5 wt. % of a fibrillated fluoropolymer;
from 0 to 5 wt. % of an additive selected from the group consisting of antioxidants, mold release agents, colorants, quenchers, stabilizers, and combinations thereof,
wherein the composition has a heat deflection temperature of at least 110° C., measured in accordance with ASTM D648 on 3.2 mm thick molded bars at 0.455 MPa.

### SUMMARY

It is an object of the present invention is to provide a thermoplastic composition having a desired combination of stiffness, toughness and flow which allows it to be suitable for the manufacture of structural parts, in particular for the manufacture of indoor or outdoor automotive parts, which are mechanically connected to a support structure.

This object is met, at least in part, in accordance with the present invention which is directed at a thermoplastic composition comprising or consisting of, based on the weight of the composition,
(A) from 50-65 wt. % of aromatic polycarbonate,
(B) from 20-40 wt. % of polyester comprising or consisting of poly(butylene terephthalate),
(C) from 1-10 wt. % of impact modifier,
(D) from 5-15 wt. % of glass fibres,
(E) from 0-5 wt. % of further components,
wherein the sum of the components (A)-(E) is 100 wt. % and wherein the composition has, or is selected to have,
   a notched Izod impact strength determined in accordance with ISO 180-1A at a temperature of 23° C. of at least 10, preferably at least 12 kJ/m²,
   a tensile modulus determined in accordance with ISO 527 at a temperature of 23° C. of at least 4.0 GPa, preferably at least 4.2 GPa,
   a tensile strength determined in accordance with ISO 527 at a temperature of 23° C. of at least 75 MPa,
   a melt volume rate determined in accordance with ISO 1133 (250° C., 5 kg) of at least 7.0 cc/10 min.

### DETAILED DESCRIPTION

### Aromatic Polycarbonate

Aromatic polycarbonates are generally manufactured using two different technologies. In a first technology, known as the interfacial technology or interfacial process, phosgene is reacted with a bisphenol, typically bisphenol A (BPA) in a liquid phase. Another well-known technology is the so-called melt technology, sometimes also referred to as melt transesterification or melt polycondensation technology. In the melt technology, or melt process, a bisphenol, typically BPA, is reacted with a carbonate, typically diphenyl carbonate (DPC), in the melt phase. Aromatic polycarbonate obtained by the melt transesterification process is known to be structurally different from aromatic polycarbonate obtained by the interfacial process. In that respect it is noted that in particular the so called “melt polycarbonate” typically has a minimum amount of Fries branching, which is generally absent in “interfacial polycarbonate”. Apart from that melt polycarbonate typically has a higher number of phenolic hydroxy end groups while polycarbonate obtained by the interfacial process is typically end-capped and has at most 150 ppm, preferably at most 50 ppm, more preferably at most 10 ppm of phenol hydroxyl end-groups.

In accordance with the invention, it is preferred that the aromatic polycarbonate comprises or consists of bisphenol A polycarbonate homopolymer (also referred to herein as bisphenol A polycarbonate). Preferably, the aromatic polycarbonate of the invention disclosed herein comprises at least 75 wt. %, preferably at least 95 wt. % of bisphenol A polycarbonate based on the total amount of aromatic polycarbonate. More preferably, the aromatic polycarbonate in the composition essentially consists or consists of bisphenol A polycarbonate. It is preferred that the aromatic polycarbonate has a weight average molecular weight (Mw) of 15,000 to 60,000 g/mol determined using gel permeation chromatography with polycarbonate standards. Preferably the Mw of the aromatic polycarbonate is from 30,000-65,000 g/mol. The aromatic polycarbonate preferably has a melt volume rate of from 4-30 cc/10 min as determined in accordance with ASTM D1238 (300° C., 1.2 kg).

In an aspect, the polycarbonate is an interfacial polycarbonate.

In another aspect, the polycarbonate is a melt polycarbonate.

In yet another aspect the polycarbonate is a mixture of from 20-80 wt. % or 40-60 wt. % of interfacial polycarbonate and from 80-20 wt. % or 60-40 wt. % of melt polycarbonate, based on the weight of the aromatic polycarbonate.

The polycarbonate may be a mixture of two or more polycarbonates differing in melt volume rate (i.e. in molecular weight). The polycarbonates of the mixture may both be a bisphenol A polycarbonate homopolymer.

In another aspect the aromatic polycarbonate comprises a polycarbonate copolymer comprising structural units of bisphenol A and structural units from another bisphenol.

In the context of the present invention the aromatic polycarbonate does not comprise or consist of a copolyestercarbonate, i.e. a copolymer of an ester and a carbonate, such as for example disclosed in U.S. Pat. No. 9,296,894.

### Polyester

The polyester of the composition disclosed herein comprises, essentially consists of or consists of poly(butylene terephthalate) (PBT). The PBT may be a mixture of two or more different poly(butylene terephthalate) s, for example a mixture of PBTs with mutually different intrinsic viscosities. The polyester may further comprise mechanically recycled PBT or PBT obtained from renewable sources such as for example on the basis of chemically recycled poly(ethylene terephthalate) (PET). Polyesters such as PBT and PET are well known to a skilled person per se.

The PBT that is used in the composition of the invention may for example be a polymer comprising polymeric units derived from terephthalic acid or a diester thereof such as dimethyl terephthalate, and polymeric units derived from a butane-diol, such as 1,4-butanediol.

The PBT may further comprise polymeric units derived from other monomers, such as in particular isophthalic acid. For example, the PBT may comprise up to 10.0 wt. % of polymeric units derived from isophthalic acid, based on the weight of the PBT. Preferably, the PBT comprises up to 5.0 wt. % of units derived from isophthalic acid, such as from 1.0-4.0 wt. %. Alternatively, the PBT may be free of monomeric units other than units derived from butane-diol and terephthalic acid or a diester thereof. In other words the PBT may be free from isophthalic acid.

The PBT may be a single polymer or may be a combination of 2 or more, preferably 2, PBT's having mutually different properties. For example, the PBT may comprise a first PBT and a second PBT each having a different intrinsic viscosity. The PBT in the composition of the invention may accordingly be a blend of such a first and second (or further) PBTs. In this aspect the first PBT may have an intrinsic viscosity of from 1.1-1.4 dl/g and the second PBT may have an intrinsic viscosity of from 0.6-0.8 dl/g.

The use of a PBT blend (or mixture) allows for the preparation of a PBT for use in the invention with an optimised and desired intrinsic viscosity which might not be obtainable by available individual PBT grades.

The PBT may have an intrinsic viscosity of from 0.6 to 1.4 dl/g, preferably from 0.8-1.4 dl/g, more preferably from 1.0 to 1.4, even more preferably from 1.0-1.2 determined in a solution of 60 wt. % phenol and 40 wt. % 1,1,2,2-tetrachloroethane at 25° C. In the aspect where the PBT is a mixture then this preferred feature applies to the said mixture.

The PBT may have a carboxylic end group content of from 10-80 mmol/kg, preferably from 20-60 mmol/kg, more preferably 20-40 mmol/kg as determined in accordance with ASTM D7409-15.

It is preferred that the polyester comprises at least 60 wt. %, preferably at least 80 wt. %, more preferably at least 90 or 95 wt. % of PBT on the basis of the weight of the polyester. Most preferably the polyester consists of the PBT, in which case the PBT is the only polyester in the composition.

In an aspect the polyester may further comprise another polyester, miscible with PBT. Such polyesters include poly(ethylene terephthalate), poly(ethylene naphthalate) (“PEN”), poly(butylene naphthalate) (PBN), poly(propylene terephthalate) (PPT), poly(cyclohexane dimethanol terephthalate) (PCT), poly(cyclohexane-1,4-dimethylene cyclohexane-1,4-dicarboxylate) also referred to as poly(1,4-cyclohexane-dimethanol 1,4-dicarboxylate) (PCCD) and copolyesters, PCTG and PETG., preferably PET. In accordance with this aspect of the invention, the composition preferably comprises from 99 to 80 wt. % of PBT and from 1 to 20 wt. % of one or more of said further polyesters, based on the weight of the polyester. It is preferred that the further polyester is PET.

In an embodiment where the polyester comprises PBT, a mixture of PBTs and a polyester not being PBT then the intrinsic viscosity of the polyester is preferably from 0.6-1.4 dl/g, preferably from 0.8-1.4 dl/g, more preferably from 1.0 to 1.4, even more preferably from 1.0-1.2.

### Impact Modifier

The thermoplastic composition of the invention comprises an impact modifier. Suitable impact modifiers are typically high molecular weight elastomeric materials derived from olefins, monovinyl aromatic monomers, acrylic and methacrylic acids and their ester derivatives, as well as conjugated dienes. The polymers formed from conjugated dienes can be fully or partially hydrogenated. The elastomeric materials can be in the form of homopolymers or copolymers, including random, block, radial block, graft, and core-shell copolymers. Combinations of impact modifiers can be used.

The impact modifier is preferably selected from the group consisting of ethylene-vinyl acetate copolymer, ethylene-methyl-acrylate copolymer, ethylene-ethyl acrylate copolymer, ethylene-butyl acrylate copolymer, low density polyethylene, maleic anhydride grafted ethylene-octene copolymer, ethylene-ethyl acrylate-glycidyl ester copolymer, ethylene-butyl acrylate-glycidyl ester copolymer, rubber modified styrene-acrylonitrile copolymer, rubber modified styrene-acrylonitrile-methyl methacrylate copolymer, styrene-acrylonitrile copolymer and combinations of at least two of the foregoing (co) polymers.

In a preferred aspect the impact modifier is selected from the group consisting of acrylate based core-shell impact modifiers, acrylonitrile-styrene-butadiene core shell impact modifiers, ethylene-acrylate copolymer impact modifiers, ethylene-acrylate-glycidyl copolymer impact modifiers and mixtures of two or more of the foregoing impact modifiers.

More preferably the impact modifier is one or more of a methyl-methacrylate butadiene-styrene core shell impact modifier (MBS), an acrylonitrile-styrene-butadiene core shell impact modifier (ABS), or an ethylene-acrylate-glycidyl copolymer impact modifier. It is most preferred that the impact modifier is MBS or ABS.

### Glass Fiber

Glass fibers are comprised in the thermoplastic composition disclosed herein in an amount of from 5-15 wt. %. So called E-glass fiber, also known as lime-alumino-borosilicate glass is preferred. For achieving optimal mechanical properties the glass fibre diameter is from 6-20 micrometer, preferably from 10-15 micrometer. In preparing the molding compositions it is convenient to use the fibre in the form of chopped strands of from 3 to 15 mm in length although roving may also be used. In articles molded from the compositions, the fibre length is typically shorter due to fibre breakage during compounding or extrusion of the composition. The length of such short (i.e. shortened) glass fibres present in final molded compositions may be less than 4 mm. The glass fibres may be treated with a coupling agent to improve adhesion to the resin matrix. Preferred coupling agents include amino, epoxy, amide or mercapto functionalized silanes.

### Further Components

The composition disclosed herein may comprise from 0-5 wt. % of further components, preferably selected from the group consisting of heat stabilisers, UV stabilisers, quenchers, primary and/or secondary anti-oxidants, colorants, mold-release agents, compatibilisers and flame retardants.

### Composition

The combination of specific types and amounts materials constituting the thermoplastic composition results in a property profile in terms of in particular toughness, stiffness and flow.

In this respect it is noted that the polycarbonate and polyester mixture provides the composition with a matrix for the glass fibres and the impact modifier. By using a blend of polycarbonate and polyester comprising PBT and compared to polycarbonate the flow properties, stress crack resistance and chemical resistance are improved while good mechanical properties and a relatively high heat distortion temperature are maintained.

The relative amounts of the polycarbonate and the polyester influence this balance of properties where generally a higher amount of polycarbonate results higher heat distortion temperature, better mechanical properties but at the same time lower flow, lower chemical resistance and lower stress cracking resistance. Compatibilisers may be used to strengthen the bond between the polyester and the polycarbonate.

In that respect it is further noted that the presence of glass fibres enhances the stiffness of the composition upon higher concentrations, generally at the expense of the flow and toughness (i.e. impact properties). Longer glass fibres may result in a higher stiffness as compared to shorter glass fibres. The presence of impact modifier enhances the toughness of the thermoplastic composition generally at the expense of stiffness and sometimes also of the flow. The type of impact modifier may influence the low temperature ductility where in particular modifiers with a higher rubber content are preferred. Accordingly the combined use of glass fibres and impact modifier allows the skilled person to design a thermoplastic composition with the desired balance of toughness and stiffness. Flow promotors may also be used to counteract any loss in flow properties of the composition if that would be desired.

The examples and comparative examples disclosed herein provide the skilled person with materials that fall inside and outside the scope of the invention and thereby constitute a basis for the development of further embodiments according to the invention without undue burden.

In accordance with the invention the thermoplastic composition comprises
(A) from 50-65 wt. % of aromatic polycarbonate,
(B) from 20-40 wt. % of polyester comprising or consisting of poly(butylene terephthalate),
(C) from 1-10 wt. % of an impact modifier,
(D) from 5-15 wt. % of glass fibres,
(E) from 0-5 wt. % of further components and
wherein the sum of the components (A)-(E) is 100 wt. %.

The amount of component (A) may be from 50-60 wt. %, preferably from 55-60 wt. %.

The amount of component (B) may be from 20-30 wt. %, preferably from 25-30 wt. %.

The amount of component (C) may be from 2-5 wt. %.

The amount of component (D) may be from 8-12 wt. %, preferably from 10-12 wt. %.

The amount of component (E) may be more than 0 wt. %, i.e. from 1-5 wt. % or 1-4 wt. %.

In accordance with the invention the thermoplastic composition has
a notched Izod impact strength determined in accordance with ISO 180-1A at a temperature of 23° C. of at least 10, preferably at least 11 or at least 12 kJ/m2,
a tensile modulus determined in accordance with ISO 527 at a temperature of 23° C. of at least 4000 MPa, preferably at least 4200 MPa,
a tensile strength determined in accordance with ISO 527 at a temperature of 23° C. of at least 75 MPa,
a melt volume rate determined in accordance with ISO 1133 (250° C., 5 kg) of at least 7 cc/10 min.

The notched Izod impact strength may be from 11-16, 12-15 or 13-15 kJ/m².

The tensile modulus may be from 4000-4500 MPa or from 4200-4400 MPa.

The tensile strength may be from 75-90 MPa or from 78-86 MPa.

The melt volume rate may be from 7-15 cc/10 min, such as from 7-11 cc/10 min or from 7-9 cc/10 min.

It is preferred that the composition further has a flexural stress of at least 125 MPa and/or a flexural modulus of at least 3700 MPa, both determined in accordance with ISO 178 at 23° C.

The flexural stress may be from 125-140 MPa.

The flexural modulus may be from 3700-4100 MPa or from 3700-4000 MPa.

Preferred ranges for the amount of the components and preferred ranges for the properties of the composition may be combined without limitation provided of course these fall within the ambit of the scope of the invention as defined herein in its broadest form. That is to say, a preferred range for one or more of the amounts and/or types of the components constituting the thermoplastic composition may be combined with a preferred range for one or more of the properties of the thermoplastic composition and all such combinations are considered as disclosed herein.

### Article & Assembly

In an aspect the present invention relates to an article comprising or consisting of the thermoplastic composition disclosed herein.

In yet a further aspect the present invention relates to an assembly comprising a carrier structure and the article disclosed herein wherein the article is mechanically connected using, at least in part, mechanical connecting means to the carrier structure. The carrier structure, at the portion where it is connected to the article, is preferably comprised of a metal such as aluminum or steel or of a composite material, preferably steel. Notwithstanding the foregoing carrier structures from thermoplastic materials either the same or different from the materials disclosed herein may also be used.

The mechanical connecting means may comprise one or more hinges, screws, nails, rivets, nuts & bolts or the like which are typically and preferably made from metal such as steel or aluminum, in particular stainless steel. Notwithstanding the foregoing, connecting means manufactured from or comprising polymer materials may also be used.

In an embodiment the article is a handle or a handle bracket which is connected to a carrier structure such as a door or a lid, for example a door, hood or tailgate of a vehicle. In this context the term bracket essentially means a support structure that is part of the handle where the bracket may be covered with an aesthetically more appealing cover layer. The bracket is considered to be the load bearing structure and accordingly the material used for its manufacture is required to have the properties as set out herein. Accordingly the article is preferably an injection moulded automotive interior or exterior article, preferably a door handle or a door handle bracket.

The invention will now be further elucidated on the basis of the following non-limiting examples.

### EXAMPLES

### Materials

| | |
|---|---|
| PC105 | Bisphenol A polycarbonate manufactured using an interfacial |
| | process, having a melt volume rate of 6 cc/10 min in |
| | accordance with ASTM D1238 (300° C., 1.2 kg) available |
| | from SABIC. |
| PC102L | Bisphenol A polycarbonate manufactured using a melt |
| | transesterification process, having a melt volume rate of |
| | 6 cc/10 min in accordance with ISO 1133 (300° C., 1.2 |
| | kg)available from SABIC |
| PC175 | Bisphenol A polycarbonate manufactured using an |
| | interfacial process, having a weight average molecular |
| | weight of about 22,000 g/mol and a melt volume rate of |
| | 26 cc/10 min in accordance with ASTM D1238 (300° C., |
| | 1.2 kg) available from SABIC. |
| PBT-1 | Poly(butylene terephthalate) having an intrinsic viscosity |
| | of 1.2 dl/g available from Chang Chun Plastics, Taiwan |
| | as PBT 1100-211X |
| PBT-2 | Poly (butylene terephthalate) having an intrinsic viscosity |
| | of 0.75 dl/g available from Chang Chun Plastics, Taiwan |
| | as PBT 1200-211D |
| ABS | HRG181 High Rubber Graft ABS Impact modifier having |
| | a polybutadiene content of 55 wt. %, available from |
| | Kumho, Korea |
| MBS | Paraloid MBS EXL 2650J core shell impact modifier |
| | having a polybutadiene content of 80 wt. %, commercially |
| | available from Dow |
| EGMA | Reactive elastomeric ethylene acrylate terpolymer, having |
| | a density of 0.94 g/cm3, a melt flow rate of 8 g/10 min |
| | (ISO 1133, 190° C., 21.6 kg) commercially available |
| | as Elvaloy 4170 from DOW. |
| GF | 10 micron diameter GF T-120H from NEG (Nippon |
| | Electric Glass) |
| MZP | Mono Zinc Phosphate, used as a quencher and commercially |
| | available from Budenheim as Budit T-21. |
| TBPP | tris(2,4-di-tert-butylphenyl)phosphite, commercially |
| | available as Irgafos 168 |
| AO | octadecyl-3-[3,5-di-tert-butyl-4-hydroxyphenyl]propionate, |
| | available from BASF as Irganox 1076 |
| CB | A masterbatch consisting of 25 wt. % carbon black and 75 |
| | wt. % bisphenol A polycarbonate homopolymer having a |
| | melt flow rate (MFR) of 7 g/10 min in accordance with |
| | ASTM D 1238 (300° C., 1.2 kg). |
| Additives | Combination of 0.05 wt. % MZP, 0.08 wt. % TBPP, 0.2 |
| | wt. % AO and 2 wt. % of CB |

The additive package (“Additives”) in all the experiments was the same and adding up to 2.38 wt. %, based on the weight of the composition.

### Measurements

| | |
|---|---|
| Melt | Melt volume rate was determined in accordance with |
| volume rate | ASTM D1238 under the load and at the temperature as |
| | specified. For the composition the melt volume rate |
| | was determined at a temperature of 250° C. and a load |
| | of 5 kg. For polycarbonate the load was 1.2 kg and the |
| | temperature 300° C. |
| Impact | Izod Notched and Un-Notched Impact was determined |
| | in accordance with ISO 180/1A measured on injection |
| | moulded specimens having dimensions of 80 × 10.0 × |
| | 4.0 mm |
| | Charpy impact (notched) was determined in accordance |
| | with ISO 179 measured on injection moulded specimens |
| | having dimensions of 80 × 10.0 × 4.0 mm. |
| Intrinsic | The intrinsic viscosity was determined in a solution of |
| viscosity | 60 wt. % phenol and 40 wt. % 1,1,2,2-tetrachloroethane |
| | at 30° C. |
| Molecular | Weight average molecular weight of polycarbonate was |
| weight | determined with GPC using polystyrene standards. |
| Tensile | Tensile modulus was determined in accordance with |
| modulus | ISO 527 at a temperature of 23° C. measured on |
| | injection moulded specimens having dimensions of |
| | 170 × 10.0 × 4.0 mm. |
| Tensile | Tensile strength was determined in accordance with |
| strength | ISO 527 at a temperature of 23° C. measured on |
| at Yield | injection moulded specimens having dimensions of |
| | 170 × 10.0 × 4.0 mm |
| Elongation | Tensile yield, or elongation at break, was determined |
| at break | in accordance with ISO 527 at a temperature of 23° C. |
| | measured on injection moulded specimens having |
| | dimensions of 170 × 10.0 × 4.0 mm |
| Flexural | Flexural modulus was determined in accordance with |
| modulus | ISO 178 measured on injection moulded specimens |
| | having dimensions of 170 × 10.0 × 4.0 mm |
| Flexural | Flexural strength was determined in accordance with |
| strength | ISO 178 measured on injection moulded specimens |
| | having dimensions of 170 × 10.0 × 4.0 mm |

In the Tables 1-3 below experimental data is presented for a number of compositions wherein:
INI @23 means the Notched izod impact measured at 23
UII @ 23 means the un-notched izod Impact measured at 23° C.
N_Charpy @ 23 means the Charpy notched impact measured at 23° C.
T_mod means the tensile modulus
T_str means the tensile stress at yield
T_yield means the elongation at break
Flex_mod means the flexural modulus
Flex_str means the flexural stress
MVR (250/5 kg) means the melt volume rate of the composition measured under a load of 5 kg and at 250° C. determined in accordance with ASTM D1238)

The compositions of the examples and comparative examples were typically extruded on a WP 25 millimeter (mm) co-rotating intermeshing twin-screw extruder having L/D of 41. The polycarbonate, polyester(s), quencher, stabilizer and impact modifier were added at the feed throat of the extruder. The extruder was set with barrel temperatures between 150° C. and 260° C. The material was run maintaining torque of 55-60% with a vacuum of 100 millibar (mbar)-800 mbar applied to the melt during compounding.

All samples were molded via injection molding with the molding machine set from 40-280° C. and mold set at 100°.

TABLE 1

| | | CE1 | CE2 | CE3 | E1 | E2 | E3 | CE4 | CE5 | E4 | CE6 |
|---|---|---|---|---|---|---|---|---|---|---|---|
| PC105 | % | 59.62 | 60.62 | 61.62 | 57.62 | 55.62 | 57.62 | 55.62 | 55.62 | 58.62 | 58.62 |
| PC102L | % | | | | | | | | | | |
| PC175 | % | | | | | | | | | | |
| PBT-1 | % | 27.00 | 27.00 | 27.00 | 27.00 | 27.00 | 27.00 | 27.00 | 27.00 | 27.00 | 27.00 |
| PBT-2 | % | | | | | | | | | | |
| ABS | % | | | | | | | | | | |
| MBS | % | | | | 2.00 | 4.00 | | | 2.00 | 2.00 | |
| EGMA | % | | | | | | 2.00 | 4.00 | 2.00 | | 2.00 |
| GF | % | 11.00 | 10.00 | 9.00 | 11.00 | 11.00 | 11.00 | 11.00 | 11.00 | 10.00 | 10.00 |
| Additives | % | 2.38 | 2.38 | 2.38 | 2.38 | 2.38 | 2.38 | 2.38 | 2.38 | 2.38 | 2.38 |
| INI @23 | kJ/m² | 5 | 7 | 7 | 11 | 13 | 12 | 15 | 14 | 10 | 11 |
| UII @ 23 | kJ/m² | 44 | 47 | 52 | 49 | 48 | 48 | 50 | 52 | 47 | 53 |
| N_Charpy @ 23 | kJ/m² | 4 | 7 | 7 | 10 | 13 | 12 | 15 | 14 | 8 | 11 |
| T_mod | GPa | 4.6 | 4.3 | 4.1 | 4.4 | 4.3 | 4.4 | 4.2 | 4.0 | 4.0 | 3.9 |
| T_str | MPa | 86 | 82 | 78 | 81 | 77 | 79 | 74 | 75 | 78 | 78 |
| T_yield | % | 3.2 | 3.4 | 3.5 | 3.3 | 3.1 | 3.3 | 3.2 | 3.1 | 3.4 | 3.2 |
| Flex_mod | GPa | 4.0 | 3.9 | 3.8 | 4.0 | 3.9 | 4.0 | 3.9 | 3.8 | 3.7 | 3.8 |
| Flex_str | MPa | 133 | 129 | 124 | 128 | 126 | 129 | 122 | 122 | 125 | 122 |
| MVR (250/5 kg) | cc/10′ | 7.8 | 8.1 | 8.5 | 8.1 | 7.4 | 7.4 | 6.8 | 6.9 | 8.6 | 7.8 |

TABLE 2

| | | E5 | CE7 | CE8 | CE9 | E6 | E7 | E8 | E9 | E10 | CE10 | CE11 | CE12 | CE13 |
|---|---|---|---|---|---|---|---|---|---|---|---|---|---|---|
| PC105 | % | 35.62 | 35.62 | 38.62 | 35.62 | 35.62 | 55.62 | 55.62 | 54.62 | 56.62 | 54.62 | 54.62 | 57.62 | 55.62 |
| PC102L | % | | | | | | | | | | | | | |
| PC175 | % | 20.00 | 20.00 | 20.00 | 20.00 | 20.00 | | | | | | | | |
| PBT-1 | % | 27.00 | 27.00 | 27.00 | 13.5 | 13.5 | | | 27.00 | 27.00 | 27.00 | 27.00 | 27.00 | 27.00 |
| PBT-2 | % | | | | 13.5 | 13.5 | 27.00 | 27.00 | | | | | | |
| ABS | % | | | | | | | | 5.00 | 3.00 | 3.00 | 3.00 | 3.00 | 5.00 |
| MBS | % | 4.00 | 2.00 | | 4.00 | 2.00 | 2.00 | 4.00 | | | | 2.00 | | |
| EGMA | % | | 2.00 | 2.00 | | 2.00 | 2.00 | | | | 2.00 | | | |
| GF | % | 11.00 | 11.00 | 10.00 | 11.00 | 11.00 | 11.00 | 11.00 | 11.00 | 11.00 | 11.00 | 11.00 | 10.00 | 10.00 |
| Additives | % | 2.38 | 2.38 | 2.38 | 2.38 | 2.38 | 2.38 | 2.38 | 2.38 | 2.38 | 2.38 | 2.38 | 2.38 | 2.38 |
| INI @23 | kJ/m² | 11 | 13 | 11 | 13 | 12 | 11 | 12 | 14 | 12 | 14 | 14 | 11 | 13 |
| UII @ 23 | kJ/m² | 46 | 49 | 52 | 51 | 47 | 42 | 50 | 66 | 65 | 58 | 49 | 50 | 52 |
| N_Charpy @ 23 | kJ/m² | 11 | 13 | 10 | 12 | 12 | 11 | 11 | 13 | 11 | 14 | 14 | 11 | 13 |
| T_mod | Gpa | 4.0 | 3.9 | 3.9 | 4.1 | 4.0 | 4.0 | 4.0 | 4 | 4 | 3.7 | 3.9 | 3.8 | 3.8 |
| T_str | MPa | 77 | 76 | 78 | 79 | 76 | 79 | 80 | 79 | 79 | 77 | 81 | 79 | 80 |
| T_yield | % | 3.1 | 3.1 | 3.4 | 3.2 | 3.1 | 3.2 | 3.1 | | | | | | |
| Flex_mod | Gpa | 3.7 | 3.6 | 3.7 | 4.0 | 3.6 | 4.0 | 4.0 | 3.8 | 3.8 | 3.7 | 3.7 | 3.7 | 3.5 |
| Flex_str | MPa | 122 | 121 | 125 | 124 | 120 | 121 | 125 | 128 | 129 | 124 | 126 | 128 | 123 |
| MVR (250/5 kg) | cc/10′ | 8.2 | 7.1 | 8.5 | 11.1 | 9.7 | 11.0 | 12.8 | 8.0 | 8.3 | 8.3 | 7.8 | 8.4 | 8.2 |

TABLE 3

| | | CE14 | E11 | E12 | E13 | E14 |
|---|---|---|---|---|---|---|
| PC105 | % | | | | | |
| PC102L | % | 61.62 | 57.62 | 59.62 | 57.62 | 56.62 |
| PC175 | % | | | | | |
| PBT-1 | % | 27.00 | 27.00 | 27.00 | 27.00 | 27.00 |
| PBT-2 | % | | | | | |
| ABS | % | | | | | 5.00 |
| MBS | % | | 4.00 | | 2.00 | |
| EGMA | % | | | 2.00 | 2.00 | |
| GF | % | 11.00 | 11.00 | 11.00 | 11.00 | 11.00 |
| Additives | % | 2.38 | 2.38 | 2.38 | 2.38 | 2.38 |
| INI @23 | kJ/m² | 8 | 14 | 12 | 15 | 15 |
| UII @ 23 | kJ/m² | 62 | 65 | 69 | 76 | 69 |
| N_Charpy @ 23 | kJ/m² | 8 | 14 | 11 | 14 | 14 |
| T_mod | GPa | 4.3 | 4.2 | 4.1 | 4.2 | 4.1 |
| T_str | MPa | 90 | 86 | 86 | 84 | 86 |
| T_yield | % | 4.4 | 4.4 | 4.4 | 4.4 | 4.4 |
| Flex_mod | GPa | 4.1 | 3.9 | 4.0 | 3.9 | 4.0 |
| Flex_str | MPa | 143 | 137 | 139 | 134 | 137 |
| MVR (250/5 kg) | cc/10′ | 8.2 | 8.0 | 7.9 | 7.1 | 7.8 |

A bracket for a door handle was manufactured with the composition of CE1 which was affixed to a carrier structure using a stainless steel screw. Upon tightening of the screw the inventors observed that the material showed cracks near the position of the screw.

Similar brackets were manufactured from the compositions of E2 and E9 and surprisingly the present inventors did not observe the formation of cracks and the bracket could be connected to the carrier structure firmly.

1. Thermoplastic composition comprising, based on the weight of the composition,
(A) from 50-65 wt. % of aromatic polycarbonate
(B) from 20-40 wt. % of polyester comprising or consisting of poly(butylene terephthalate)
(C) from 1-10 wt. % of impact modifier
(D) from 5-15 wt. % of glass fibres
(E) from 0-5 wt. % of further components
wherein the sum of the components (A)-(E) is 100 wt. % and wherein the composition has
a notched Izod impact strength determined in accordance with ISO 180-1A at a temperature of 23° C. of at least 10 kJ/m2,
a tensile modulus determined in accordance with ISO 527 at a temperature of 23° C. of at least 4.0 GPa,
a tensile strength determined in accordance with ISO 527 at a temperature of 23° C. of at least 75 MPa,
a melt volume rate determined in accordance with ISO 1133 (250° C., 5 kg) of at least 7.0 cc/10 min.

2. The composition of claim 1 wherein the polyester comprises at least 80 wt. %, based on the weight of the polyester of poly(butylene terephthalate).

3. The composition of claim 1 wherein the impact modifier is selected from the group consisting of acrylate based core-shell impact modifiers, acrylonitrile-styrene-butadiene core shell impact modifiers, ethylene-acrylate copolymer impact modifiers, ethylene-acrylate-glycidyl copolymer impact modifiers and mixtures of two or more of the foregoing impact modifiers.

4. The composition of any claim 1 wherein the aromatic polycarbonate comprises two or more aromatic polycarbonates having different melt volume rates and/or wherein the polyester comprises two or more poly(butylene terephthalate) s having different intrinsic viscosities.

5. The composition of claim 1 wherein the poly(butylene terephthalate or the mixture of poly(butylene terephthalates) has an intrinsic viscosity of from 0.6 to 1.4 dl/g.

6. The composition of claim 1 wherein the aromatic polycarbonate consists of bisphenol A polycarbonate or a mixture of bisphenol A polycarbonates.

7. The composition of claim 1 wherein the aromatic polycarbonate has a melt volume rate of from 4-30 cc/10 min as determined in accordance with ASTM D1238 (300° C., 1.2 kg) and/or wherein the polyester has an intrinsic viscosity of from 0.6-1.4 dl/g as determined in accordance with the method set out in the specification.

8. The composition of claim 1 further having a flexural stress of at least 125 MPa and/or a flexural modulus of at least 3700 MPa, both determined in accordance with ISO 178 at 23° C.

9. The composition of claim 1 comprising
(A) from 50-60 wt. % of aromatic polycarbonate
(B) from 20-30 wt. % of polyester comprising or consisting of poly(butylene terephthalate)
(C) from 2-5 wt. % of impact modifier
(D) from 10-12 wt. % of glass fibres
(E) from 0-5 wt. % of further components,
wherein the sum of the components (A)-(E) is 100 wt. %.

10. An article of manufacture comprising or consisting of the thermoplastic composition according to claim 1.

11. The article of claim 9 wherein the article is an injection moulded automotive interior or exterior article.

12. An assembly comprising a carrier structure and the article of claim 1 wherein the article is mechanically connected to the carrier structure at least in part using mechanical connecting means.

13. The assembly of claim 11 wherein the mechanical connecting means is selected from the group consisting of screws, nuts and bolts, rivets or combinations of two or more of these connecting means.

14. The assembly of claim 11 wherein the carrier structure, at the portion where it is connected to the article is comprised of a metal.
